(19) United States
(12) Patent Application Publication
(10) Pub. No.: US 2009/0244324 A1
(43) Pub. Date: Oct. 1, 2009

(54) IMAGING DEVICE

(75) Inventors: Satoshi Saito, Nomi-shi (JP); Seiji Koshiyama, Iga-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Osaka (JP)

(21) Appl. No.: 12/409,017

(22) Filed: Mar. 23, 2009

(30) Foreign Application Priority Data
Mar. 28, 2008 (JP) 2008-086274

(51) Int. Cl. H04N 5/76; H04N 5/232

(52) U.S. Cl. 348/231.99; 348/347; 348/E05.045; 348/E05.031

(57) ABSTRACT

A digital camera as one example of an imaging device includes an image sensor, and by utilizing this, an optical image of an object scene is repeatedly captured. A partial object scene image belonging to a zoom area of the object scene image produced by the image sensor is subjected to zoom processing by a zooming circuit, and the obtained zoomed object image is displayed on a monitor screen of an LCD by an LCD driver. A CPU detects a facial image from the produced object scene image through a face detecting circuit, calculates the position of the detected facial image with respect to the zoom area, and displays the position information indicating the calculated position on a mini-screen within the monitor screen by controlling a character generator and the LCD driver.

### CROSS REFERENCE OF RELATED APPLICATION

The disclosure of Japanese Patent Application No. 2008-86274 is incorporated herein by reference.

### BACKGROUND OF THE INVENTION

1. Field of the Invention

The present invention relates to an imaging device. More specifically, the present invention relates to an imaging device having an electronic zooming function and a face detecting function.

2. Description of the Related Art

In zoom photographing, a user generally moves an optical axis of an imaging device with reference to the monitor screen in a state that the zoom is canceled, and introduces an object which is being noted, face, for example, into approximately the center of the object scene. Then, the optical axis of the imaging device is fixed, and the zoom operation is performed. Thus, it is possible to easily introduce the face image into the zoom area.

However, when the zoom magnification becomes high, a slight movement of the optical axis due to the movement of the body of the user causes the facial image to lie off the zoom area. When the facial image extends off the zoom area, it is not easy to introduce this into the zoom area again. Thus, the user has to perform a zoom cancelling operation once, and then try to introduce it again.

### SUMMARY OF THE INVENTION

The present invention employs following features in order to solve the above-described problems.

An imaging device according to a first invention comprises an imager for repeatedly capturing an optical image of an object scene; a zoomer for performing zoom processing on a partial object scene image belonging to a zoom area of the object scene image produced by the imager; a first displayer for displaying a zoomed object image produced by the zoomer on a first screen; a detector for detecting a specific image from the object scene image produced by the imager; and a second displayer for displaying position information indicating a position of the specific image detected by the detector with respect to the zoom area on a second screen.

In the first invention, an imaging device has an imager, and the imager repeatedly captures an optical image of an object scene. A partial object scene image belonging to a zoom area of the object scene image produced by the imager is subjected to zoom processing by a zoomer. The zoomed object image thus generated is displayed on a first screen by a first displayer. On the other hand, from the object scene image generated by the imager, a specific image is detected by a detector. A second displayer displays position information indicating a position of the detected specific image with respect to the zoom area on a second screen.

According to the first invention, the zoomed object image of the zoom area of the object scene image is displayed on the first screen, and the information indicating the position of the specific image detected from the object scene image with respect to the zoom area is displayed on the second screen. The specific image here can also be detected from the part not belonging to the zoom area of the object scene image, and therefore, it is possible to produce information indicating the position of the specific image with respect to the zoom area. Accordingly, the user can know a positional relation between the specific object and the first screen, that is, a positional relation between the specific image and the zoom area with reference to the position information on the second screen. Thus, it is possible to easily introduce the specific image into the zoom area smoothly.

Additionally, in the preferred embodiment, the second screen is included in the first screen (typically, is subjected to an on-screen display). However, the first screen and the second screen may be independent of each other, and parts thereof may be shared.

Furthermore, the specific object may typically be faces of persons, but may be inanimate matters, such as animals, plants, soccer balls except for persons.

An imaging device according to a second invention is dependent on the first invention, and the second displayer displays the position information when the specific image detected by the detector lies outside the zoom area while it erases the position information when the specific image detected by the detector lies inside the zoom area.

In the second invention, the position information is displayed only when the specific image lies outside the zoom area. That is, the position information is displayed when a need for introduction is high, and this is erased when a need for introduction is low, and therefore, it is possible to improve operability when the position information is introduced.

An imaging device according to a third invention is dependent on the first invention, and the position information includes a specific symbol corresponding to the specific image detected by the detector and an area symbol corresponding to the zoom area, and positions of the specific symbol and the area symbol on the second screen are equivalent to positions of the specific image and the zoom area on the object scene image (imaging area).

According to the third invention, the user can intuitively know the positional relation between the specific image and the zoom area.

An imaging device according to a fourth invention is dependent on the first invention, and the detector includes a first detector for detecting a first specific image given with the highest notice and a second detector for detecting a second specific image given with a notice lower than that of the first specific image, and the second displayer displays a first symbol corresponding to the detection result of the first detector and a second symbol corresponding to the detection result of the second detector in different manners.

In the fourth invention, the first symbol with the highest notice is displayed in a manner different from the second symbol with a notice lower than that of the first specific image. Accordingly, when another specific object being different from the specific object which is being noted appears within the object scene, the user can easily discriminate one from another, capable of preventing confusion from occurring in the introduction.

Here, the degree of note of each of the plurality of specific images is determined on the basis of the positional relation, the magnitude relation, and the perspective relation between the plurality of specific images, etc. Furthermore, the display manner is a color, brightness, size, shape, transmittance, and a cycle of flash, for example.

An imaging device according to a fifth invention comprises an imager for repeatedly capturing an optical image of an object scene; a zoomer for performing zoom processing on a partial object scene image belonging to a zoom area of the object scene image produced by the imager; a first displayer for displaying a zoomed object image produced by the zoomer on a first screen; a detector for detecting a specific image from the object scene image produced by the imager; a follower for causing the zoom area to follow a displacement of the specific image when the specific image detected by the detector lies inside the zoom area; and a second displayer for displaying position information indicating a position of the zoom area with respect to the object scene image produced by the imager.

In the fifth invention, the imaging device comprises an imager, and the imager repeatedly captures an optical image of an object scene. A partial object scene image belonging to a zoom area of the object scene image produced by the imager is subjected to zoom processing by a zoomer. The zoomed object image thus generated is displayed on a first screen by a first displayer. On the other hand, from the object scene image generated by the imager, a specific image is detected by a detector. A follower causes the zoom area to follow a displacement of the specific image when the specific image detected by the detector lies inside the zoom area. A second displayer displays position information indicating a position of the zoom area with respect to the object scene image produced by the imager.

According to the fifth invention, the zoomed object image belonging to the zoom area of the object scene image is displayed on the first screen. The zoom area here follows the movement of the specific image, so that it is possible to maintain a condition that the specific object is displayed on the first screen. On the other hand, on the second screen, information indicating the position of the zoom area with respect to the object scene image (imaging area) is displayed, which allows the user to know which part of the object scene image is displayed on the first screen. Consequently, the user can adjust the direction of the optical axis of the imager such that the zoom area is arranged at the center of the object scene image as precise as possible, capable of ensuring an area followed by the zoom area.

An imaging device according to a sixth invention is dependent on the fifth invention, and the position information includes an area symbol corresponding to the zoom area, and a position of the area symbol on the second screen is equivalent to a position of the zoom area on the object scene image.

According to the sixth invention, the user can intuitively know the position of the zoom area within the object scene image.

An imaging device according to a seventh invention comprises an imager for repeatedly capturing an optical image of an object scene; a zoomer for performing zoom processing on a partial object scene image belonging to a zoom area of the object scene image produced by the imager; a first displayer for displaying the zoomed object image produced by the zoomer on a first screen; a detector for detecting a specific image from the object scene image produced by the imager; and a second displayer for displaying on the screen direction information indicating a direction of the specific image with respect to the zoom area when the specific image detected by the detector moves from inside the zoom area to outside it.

In the seventh invention, an imaging device has an imager, and the imager repeatedly captures an optical image of an object scene. A partial object scene image belonging to a zoom area out of the object scene image produced by the imager is subjected to zoom processing by a zoomer. The zoomed object image thus generated is displayed on a screen by a first displayer. On the other hand, from the object scene image generated by the imager, a specific image is detected by a detector. A second displayer displays on the screen direction information indicating a direction of the specific image with respect to the zoom area when the detected specific image detected moves from inside the zoom area to outside it.

According to the seventh invention, on the screen, the information indicating the direction of the specific image detected from the object scene image with respect to the zoom area object scene image is displayed together with the zoomed object image belonging to the zoom area of the object scene image. Here, the specific image can also be detected from the part not belonging to the zoom area of the object scene image, and therefore, it is possible to produce information indicating the direction of the specific image with respect to the zoom area. Accordingly, when the specific object disappears from the screen, the user can know which direction the specific object lies with respect to the screen, that is, the direction of the specific image by referring to the zoom area with reference to the direction information displayed on the screen. Thus, it is possible to smoothly introduce the specific image into the zoom area.

An imaging device according to an eighth invention is dependent on the seventh invention, and further comprises an erasure for erasing the direction information from the screen when the specific image detected by the detector moves from outside the zoom area to inside it after the display by the second displayer.

In the eighth invention, the direction information is displayed during when the specific image is positioned outside the zoom area. That is, the direction information is displayed when a need for introduction is high, and erased when a need for introduction is low, and therefore, it is possible to improve operability when the direction information is introduced.

An imaging device according to a ninth invention comprises an imager for repeatedly capturing an optical image of an object scene; a zoomer for performing zoom processing on a partial object scene image belonging to a zoom area of the object scene image produced by the imager; a displayer for displaying a zoomed object image produced by the zoomer on a screen; a detector for detecting a specific image from the object scene image produced by the imager; and a zoom magnification reducer for reducing a zoom magnification of the zoomer when the specific image detected by the detector moves from inside the zoom area to outside it, wherein the displayer displays the object scene image produced by the imager on the screen in response to the zoom magnification reducing processing by the zoom magnification reducer.

In the ninth invention, an imaging device has an imager, and the imager repeatedly captures an optical image of an object scene. A partial object scene image belonging to a zoom area out of the object scene image produced by the imager is subjected to zoom processing by a zoomer. The zoomed object image thus generated is displayed on a screen by a displayer. On the other hand, from the object scene image generated by the imager, a specific image is detected by a detector. When the detected specific image moves from inside the zoom area to outside it, the zoom magnification by the zoomer is reduced by a zoom magnification reducer. The displayer displays the object scene image produced by the imager on the screen in response to the zoom magnification reducing processing by the zoom magnification reducer.

According to the ninth invention, the zoomed object image belonging to the zoom area of the object scene image is displayed on the screen. When the specific image moves from inside the zoom area to outside it, the zoom magnification is reduced. Accordingly, the angle of view is widened in response to the specific object lying off the screen, and therefore, the specific object falls within the screen again. Thus, it is possible to introduce the specific image into the zoom area smoothly.

An imaging device according to a tenth invention is dependent on the ninth invention, and comprises a zoom magnification increaser for increasing the zoom magnification of the zoomer when the specific image detected by the detector moves from outside the zoom area to inside it after the zoom magnification reduction by the zoom magnification reducer, wherein the displayer displays the zoomed object image produced by the zoomer on the screen in response to the zoom magnification increasing processing by the zoom magnification increaser.

According to the tenth invention, the zoom magnification is increased when the specific image moves from outside the zoom area to inside it after the reduction in the zoom magnification, capable enhancing operability in the introduction.

A control program according to an eleventh invention causes a processor of an imaging device comprising an imager for repetitively capturing an optical image of an object scene, a zoomer for performing zoom processing on a partial object scene image belonging to a zoom area of the object scene image produced by the imager, a first displayer for displaying a zoomed object image produced by the zoomer on a first screen, a detector for detecting a specific image from the object scene image produced by the imager, and a second displayer for displaying information in relation to the specific image detected by the detector on a second screen, to execute following steps of: a position calculating step for calculating a position of the specific image detected by the detector with respect to the zoom area; and a position information displaying step for instructing the second displayer to display position information indicating the position calculated by the calculating step on the second screen.

In the eleventh invention, it is also possible to smoothly introduce the specific image into the zoom area similar to the first invention.

A control program according to a twelfth invention causes a processor of an imaging device comprising an imager for repeatedly capturing an optical image of an object scene, a zoomer for performing zoom processing on a partial object scene image belonging to a zoom area of the object scene image produced by the imager, a first displayer for displaying a zoomed object image produced by the zoomer on a first screen, a detector for detecting a specific image from the object scene image produced by the imager, and a second displayer for displaying information in relation to the specific image detected by the detector on a second screen, to execute following steps of: a position calculating step for calculating a position of the specific image detected by the detector with respect to the zoom area; a position change calculating step for calculating the change of the position when the position calculated by the position calculating step is inside the zoom area; a zoom area moving step for instructing the zoomer to move the zoom area on the basis of the calculation result by the position change calculating step; and a position information displaying step for instructing the second displayer to display the position information indicating the position calculated by the calculating step on the second screen.

In the twelfth invention, it is also possible to retain a condition that the specific object is displayed and a range followed by the zoom area similar to the fifth invention.

A control program according to a thirteenth invention causes a processor of an imaging device comprising an imager for repeatedly capturing an optical image of an object scene, a zoomer for performing zoom processing on a partial object scene image belonging to a zoom area of the object scene image produced by the imager, a first displayer for displaying the zoomed object image produced by the zoomer on a screen, a detector for detecting a specific image from the object scene image produced by the imager, and a second displayer for displaying information in relation to the specific image detected by the detector, to executes the following steps of: a position calculating step for calculating a position of the specific image detected by said detector with respect to the zoom area; a direction calculating step for calculating, when the position calculated by the position calculating step moves from inside said zoom area to outside it, a direction of the movement; and a direction information displaying step for instructing the second displayer to display direction information indicating the direction calculated by the direction calculating step on the screen.

In the thirteenth invention, it is also possible to introduce the specific image into the zoom area similar to the seventh invention.

A control program according to the fourteenth invention causes a processor of an imaging device comprising an imager for repeatedly capturing an optical image of an object scene, a zoomer for performing zoom processing on a partial object scene image belonging to a zoom area of the object scene image produced by the imager, a displayer for displaying the zoomed object image produced by the zoomer on a screen, and a detector for detecting a specific image from the object scene image produced by the imager, to execute following steps of: a position calculating step for calculating a position of the specific image detected by the detector with respect to the zoom area; and a zoom magnification reducing step for reducing the zoom magnification of the zoomer when the position calculated by the calculating step moves from inside the zoom area to outside it.

According to the fourteenth invention, it is also possible to smoothly introduce the specific image into the zoom area similar to the ninth invention.

The above described features and other features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of each of the first to fourth embodiments of this invention;

FIG. 2(A)-FIG. 2(C) are illustrative views showing one example of a change of a monitor image in accordance with movement of a face on an imaging surface in a normal mode applied to each of the embodiments;

FIG. 3(A)-FIG. 3(C) are illustrative views showing one example of a change of the monitor image in accordance with a movement of a face on the imaging surface in a face position displaying mode 1 applied to the first embodiment;

FIG. 4(A)-FIG. 4(C) are illustrative views showing another example of a change of the monitor image in accordance with a movement of the face on the imaging surface in the face position displaying mode 1 applied to the first embodiment;

FIG. 5(A)-FIG. 5(C) are illustrative views showing one example of a change of the monitor image in accordance with a movement of a face on the imaging surface in a face position displaying mode 2 applied to the first embodiment;

FIG. 6(A)-FIG. 6(C) are illustrative views showing one example of a face symbol display position calculating method applied to the first embodiment;

FIG. 7 is a flowchart showing a part of an operation of a CPU applied to the first embodiment;

FIG. 8 is a flowchart showing another part of the operation of the CPU applied to the first embodiment;

FIG. 9 is a flowchart showing a still another part of the operation of the CPU applied to the first embodiment;

FIG. 10 is a flowchart showing a further another part of the operation of the CPU applied to the first embodiment;

FIG. 11(A)-FIG. 11(C) are illustrative views showing one example of a change of the monitor image in accordance with a movement of the face on the imaging surface in an automatically following+cut-out position displaying mode applied to the second embodiment;

FIG. 12(A) and FIG. 12(B) are illustrative views showing one example of following processing applied to the second embodiment;

FIG. 13(A)-FIG. 13(C) are illustrative views showing one example of a procedure for calculating a display position of an area symbol in the automatically following+cut-out position displaying mode;

FIG. 14 is a flowchart showing a part of an operation of the CPU applied to the second embodiment;

FIG. 15 is a flowchart showing another part of the operation of the CPU applied to the second embodiment;

FIG. 16(A)-FIG. 16(C) are illustrative views showing a change of the monitor image in accordance with a movement of the face on the imaging surface in a face direction displaying mode applied to the third embodiment;

FIG. 17(A) and FIG. 17(B) are illustrative views showing one example of a face direction displaying method applied to the third embodiment;

FIG. 18 is a flowchart showing a part of an operation of the CPU applied to the third embodiment;

FIG. 19 is a flowchart showing another part of the operation of the CPU applied to the third embodiment;

FIG. 20 is an illustrative view showing another example of a face direction calculating method applied to the third embodiment;

FIG. 21(A)-FIG. 21(C) are illustrative views showing a change of the monitor image in accordance with a movement of the face on the imaging surface in a zoom-temporarily-canceling mode applied to the fourth embodiment; and

FIG. 22 is a flowchart showing a part of an operation of the CPU applied to the fourth embodiment.

### DETAILED DESCRIPTION OF THE PREFERRED EMBODIMENTS

### First Embodiment

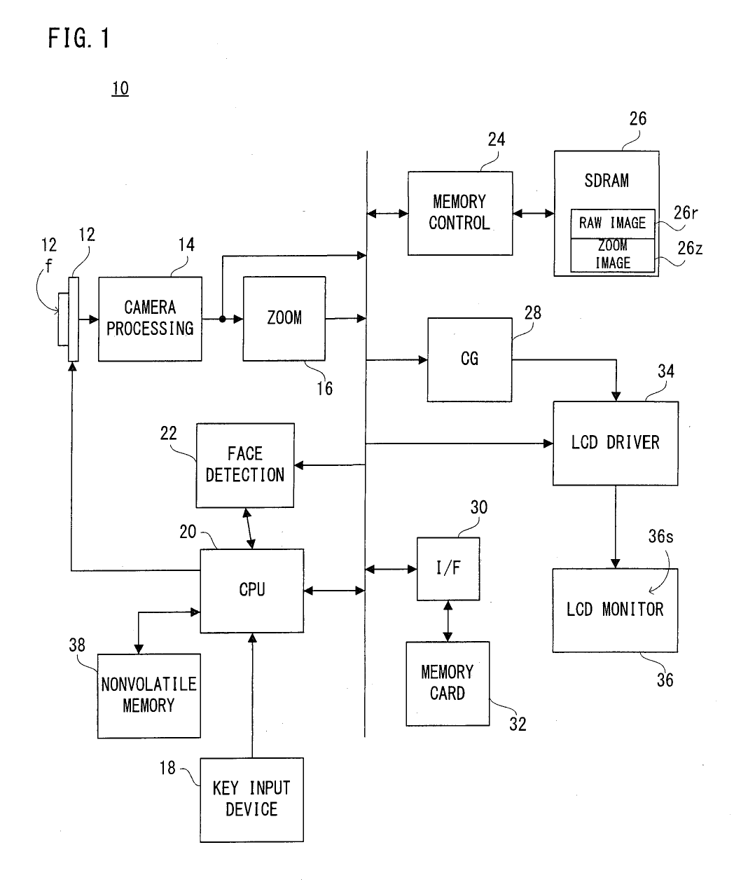

Referring to FIG. 1, a digital camera 10 of this embodiment includes an image sensor 12. An optical image of an object scene is irradiated onto the image sensor 12. An imaging area 12f of the image sensor 12 includes charge-coupled devices of 1600×1200 pixels, for example, and on the imaging area 12f, electric charges corresponding to the optical image of the object scene, that is, a raw image signal of 1600×1200 pixels is generated by a photoelectronic conversion.

When a power source is turned on, the CPU 20 instructs the image sensor 12 to repetitively execute a pre-exposure and a thinning-out reading in order to display a real-time motion image of the object, that is, a through-image on an LCD monitor 36. The image sensor 12 repetitively executes a pre-exposure and a thinning-out reading of the raw image signal thus generated in response to a vertical synchronization signal (Vsync) generated every 1/30 second. A raw image signal of 320×240 pixels corresponding to the optical image of the object scene is output from the image sensor 12 at a rate of 30 fps.

The output raw image signal is subjected to processing, such as an A/D conversion, a color separation, a YUV conversion, etc. by a camera processing circuit 14. The image data in a YUV format thus generated is written to an SDRAM 26 by a memory control circuit 24, and then read by this memory control circuit 24. The LCD driver 34 drives the LCD monitor 36 according to the read image data to thereby display a through-image of the object scene on a monitor screen 36s of the LCD monitor 36.

When a shutter operation is performed by the key input device 18, the CPU 20 instructs the image sensor 12 to perform a primary exposure and reading of all the electric charges thus generated in order to execute a main imaging processing. Accordingly, all the electric charges, that is, a raw image signal of 1600×1200 pixels is output from the image sensor 12. The output raw image signal is converted into raw image data in a YUV format by the camera processing circuit 14. The converted raw image data is written to the SDRAM 26 through the memory control circuit 24. The CPU 20 then instructs an I/F 30 to execute recording processing of the image data stored in the SDRAM 26. The I/F 30 reads the image data from the SDRAM 26 through the memory control circuit 24, and records an image file including the read image data in a memory card 32.

When a zoom operation is performed by the key input device 18, the CPU 20 changes a thinning-out ratio of the image sensor 12, sets a zoom area E according to the designated zoom magnification to a zooming circuit 16, and then commands execution of the zoom processing. For example, when the designated zoom magnification is two times, the thinning-out ratio is changed from 4/5 to 2/5. Assuming that the imaging area 12f is (0, 0)-(1600, 1200), the zoom area E is set to (400, 300)-(1200, 900).

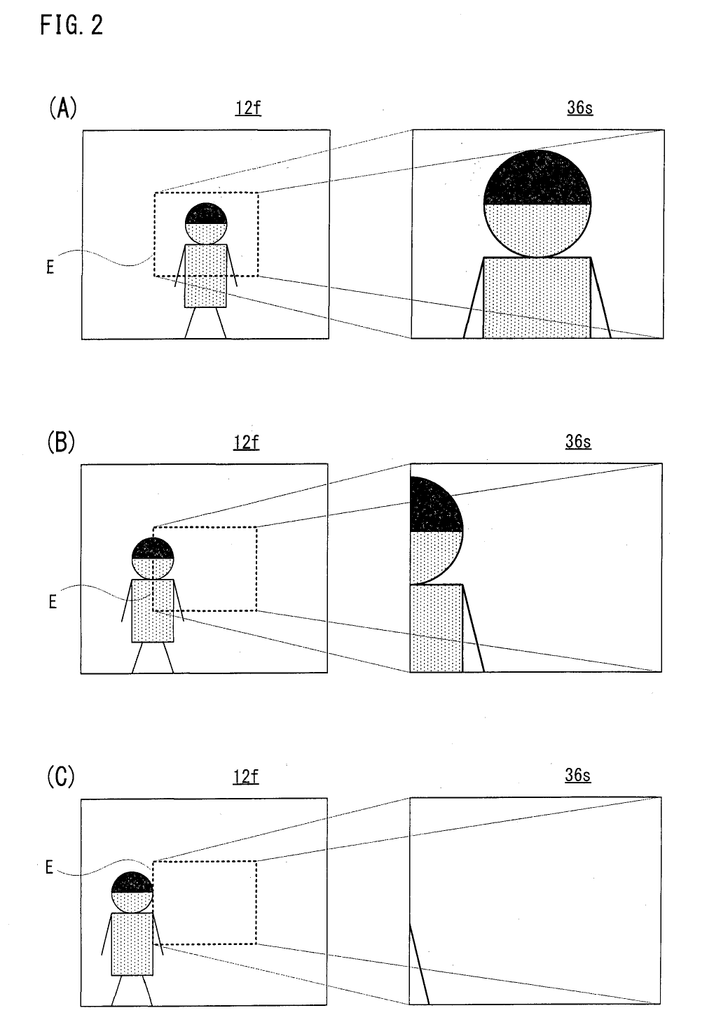

The raw image data which is read from the image sensor 12 and passes through the camera processing circuit 14 is applied to the zooming circuit 16. The zooming circuit 16 clips the raw image data belonging to the zoom area E from the applied raw image data. Depending on the designated zoom magnification, interpolation processing is performed on the clipped image data. The zoomed image data thus produced is applied to the LCD driver 34 through the SDRAM 26, so that the through-image on the monitor screen 36s is size-enlarged at the center (see FIG. 2(A)).

Then, when a shutter operation is performed by the key input device 18 in a state of 2× zoom, the CPU 20 instructs the image sensor 12 to perform a primary exposure and reading of all the electric charges. All the electric charges, that is, a raw image signal of 1600×1200 pixels is output from the image sensor 12. The output raw image signal is converted into raw image data in a YUV format by the camera processing circuit 14. The converted raw image data is applied to the zooming circuit 16.

The zooming circuit 16 first clips the raw image data belonging to the zoom area E, that is, (400, 300)-(1200, 900) from the applied raw image data of 1600×1200 pixels. Next, interpolation processing is performed on the raw image data of the clipped 800×600 pixels to thereby produce zoomed image data for recording resolution, that is, 1600×1200 pixels.

The zoomed image data thus produced is written to the SDRAM 26 through the memory control circuit 24. The I/F 30 reads the zoomed image data from the SDRAM 26 through the memory control circuit 24 under the control of the CPU 20, and records an image file including the read zoomed image data in the memory card 32.

The above is a basic operation, that is, an operation in a “normal mode” of the digital camera 10. In the normal mode, when the face of the person moves after being captured by 2× zoom, the optical image on the imaging area 12f and the through-image on the monitor screen 36s are changed as shown in FIG. 2(A)-FIG. 2(C). Referring to FIG. 2(A), the optical image of the face is first placed at the center part of the imaging area 12f, that is, within the zoom area E, and the entire face is displayed on the monitor screen 36s. Then, when the person moves, a part of the optical image of the face lies off the zoom area E, and a part of the through-image of the face also lies off the monitor screen 36s as shown in FIG. 2(B). When the person further moves, the optical image of the entire face is displaced out of the zoom area E, and the through-image of the face disappears from the monitor screen 36s as shown in FIG. 2(C). Here, at this point, the optical image of the face still lies on the imaging area 12f.

When a “face position displaying mode 1” is selected by the key input device 18, the CPU 20 instructs the image sensor 12 to repetitively perform a pre-exposure and a thinning-out reading similar to the normal mode. A raw image signal of 320×240 pixels is output from the image sensor 12 at a rate of 30 fps to thereby display a through-image of the object scene on the monitor screen 36s. The recording processing to be executed in response to a shutter operation is also similar to that in the normal mode.

When a zoom operation is performed by the key input device 18, the CPU 20 changes the thinning-out ratio of the image sensor 12, sets the zoom area E according to the designated zoom magnification to the zooming circuit 16, and then, executes zoom processing similar to the normal mode.

The raw image data which is read from the image sensor 12 and passes through the camera processing circuit 14 is applied to the zooming circuit 16, and written to a raw image area 26r of the SDRAM 26 through the memory control circuit 24. The zooming circuit 16 clips the image data belonging to the zoom area E, that is, (400, 300)-(1200, 900) from the applied raw image data. If the resolution of the clipped image data does not satisfy the resolution for display, that is, 320×240, the zooming circuit 16 further performs interpolation processing on the clipped image data. The zoomed image data of 320×240 pixels thus produced is written to a zoomed image area 26z of the SDRAM 26 through the memory control circuit 24.

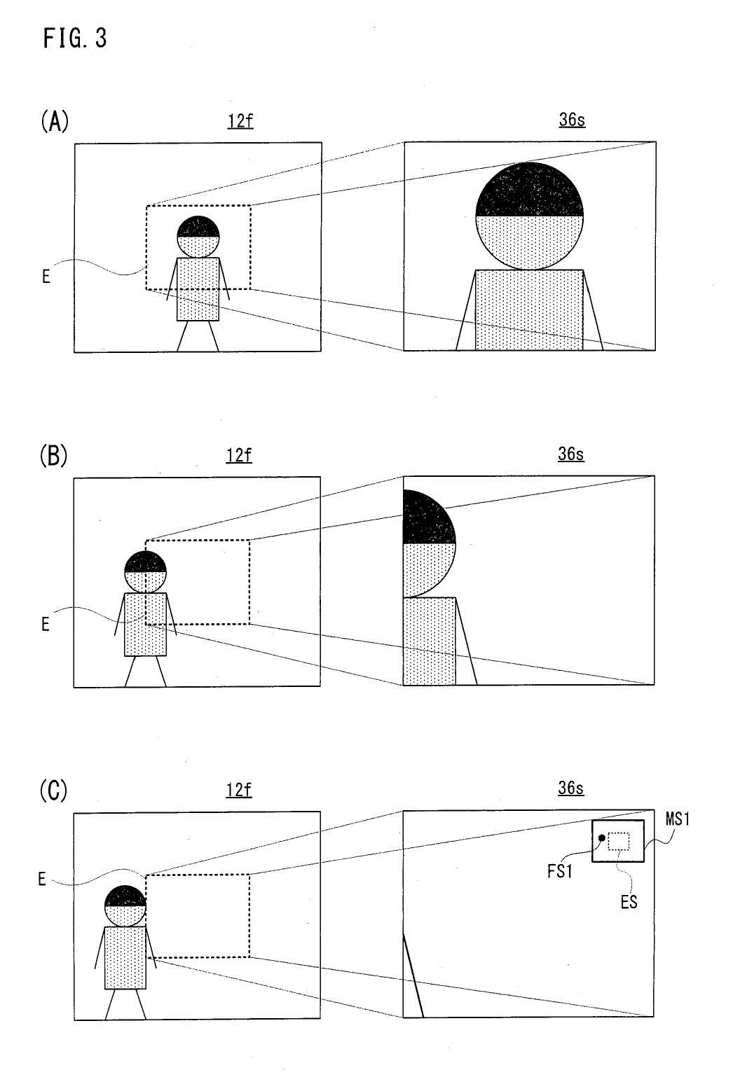

The zoomed image data stored in the zoomed image area 26z is then applied to the LCD driver 34 through the memory control circuit 24. Consequently, the through-image on the monitor screen 36s is size-enlarged at the center part (see FIG. 3(A)).

The image data stored in the raw image area 26r is then read through the memory control circuit 24, and applied to a face detecting circuit 22. The face detecting circuit 22 performs face detection processing by noting the applied image data under the control of the CPU 20. The face detection processing here is a type of pattern recognizing processing for checking the noted image data with dictionary data corresponding to eyes, a nose, and a mouth of the person. When the facial image is detected, the CPU 20 calculates the position, and holds the face position data indicating the calculation result in the nonvolatile memory 38.

The CPU 20 determines whether or not the facial image lies inside the zoom area E on the basis of the face position data held in the nonvolatile memory 38. Then, when the facial image lies outside the zoom area E, a mini-screen MS1 display instruction is issued while when the facial image lies inside the zoom area E, a mini-screen MS1 erasing instruction is issued.

When the display instruction is issued, a character generator (CG) 28 generates image data of the mini-screen MS1. The mini-screen MS1 includes a face symbol FS corresponding to the detected facial image and an area symbol ES corresponding to the zoom area E. The mini-screen MS1 has a size in the order of a fraction of the monitor screen 36s, and the face symbol FS is represented by a red dot.

The generated image data is applied to the LCD driver 34, and the LCD driver 34 displays the mini-screen MS1 so as to be overlapped with the through-image on the monitor screen 36s under the control of the CPU 20. The mini-screen MS1 is displayed at a preset position, such as at the upper right corner within the monitor screen 36s.

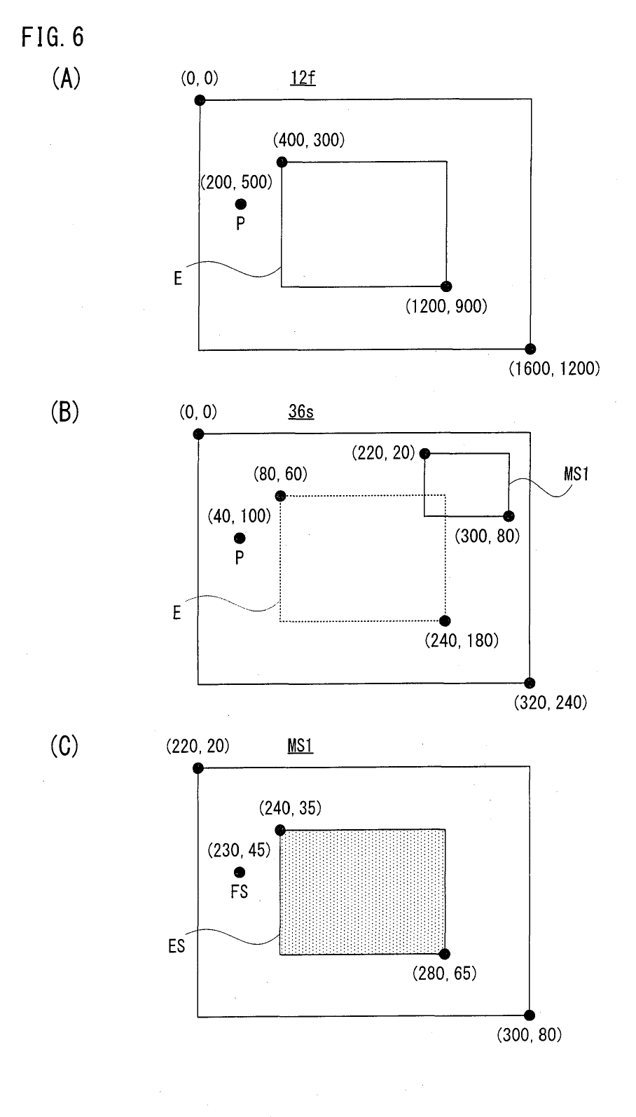

As shown in FIG. 6(A)-FIG. 6(C), the position and size of the area symbol ES with respect to the mini-screen MS1 are equivalent to the position and size of the zoom area E with respect to the imaging area 12f. Furthermore, the position of the face symbol FS within the mini-screen MS1 is equivalent to the position of the optical image of the face within the imaging area 12f. Thus, assuming that the display area of the mini-screen MS1 is (220, 20)-(300, 80), the display area of the area symbol ES becomes (240, 35)-(280, 65). Furthermore, when the detected face position is (40, 100), the display position of the face symbol FS is calculated to equal (230, 45).

Accordingly, in the face position displaying mode 1, when the person moves after the face of the person is captured by 2× zoom, the optical image on the imaging area 12f and the through-image on the monitor screen 36s are changed as shown in FIG. 3(A)-FIG. 3(C). The change in the normal mode, that is, the difference from the FIG. 2(A) to FIG. 2(C) is that the mini-screen MS1 is displayed on the monitor screen 36s when the facial image disappears from the monitor screen 36s, that is, at a timing shown in FIG. 3(C).

Here, the display timing is a time when the entire facial image is out of the zoom area E in this embodiment, but this may be a time when at least a part of the facial image is out of the zoom area E, or a time when the central point of the facial image (the middle point between the eyes, for example) is out of the zoom area E. The display timing may be switched by change of the setting through the key input device 18.

Even if the facial image disappears from the monitor screen 36s, the user can know the position of the face (in which area of the imaging area 12f the optical image of the face is present) or a positional relation between the zoom area E and the facial image with reference to the mini-screen MS1, so that the user can turn the face toward the optical axis of the image sensor 12. Thus, if the facial image is returned to the monitor screen 36s, the mini-screen MS1 is erased from the monitor screen 36s.

Here, the erasure timing is a time when at least a part of the facial image enters the zoom area E. However, this may be set to the time when the entire facial image enters the zoom area E, or at a time when the central point of the facial image enters the zoom area E.

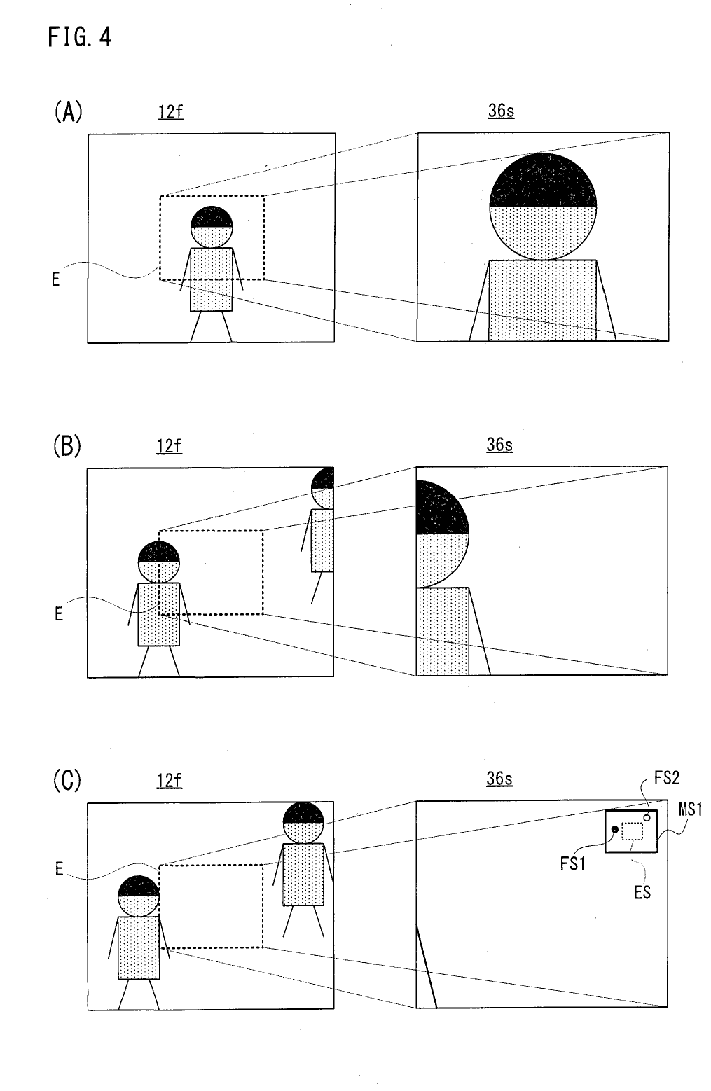

Furthermore, a plurality of facial images may simultaneously be detected. For example, as shown in FIG. 4(A)-FIG. 4(C), when the facial image captured by 2× zoom lies off the zoom area, if another facial image is present within the object scene, the mini-screen MS1 including the area symbol ES and two face symbols FS1 and FS2 is displayed. In this case, the face symbol FS1, that is, the face symbol corresponding to the facial image which lies off the zoom area E is displayed by red while the face symbol FS2 is displayed by a color different therefrom, like blue.

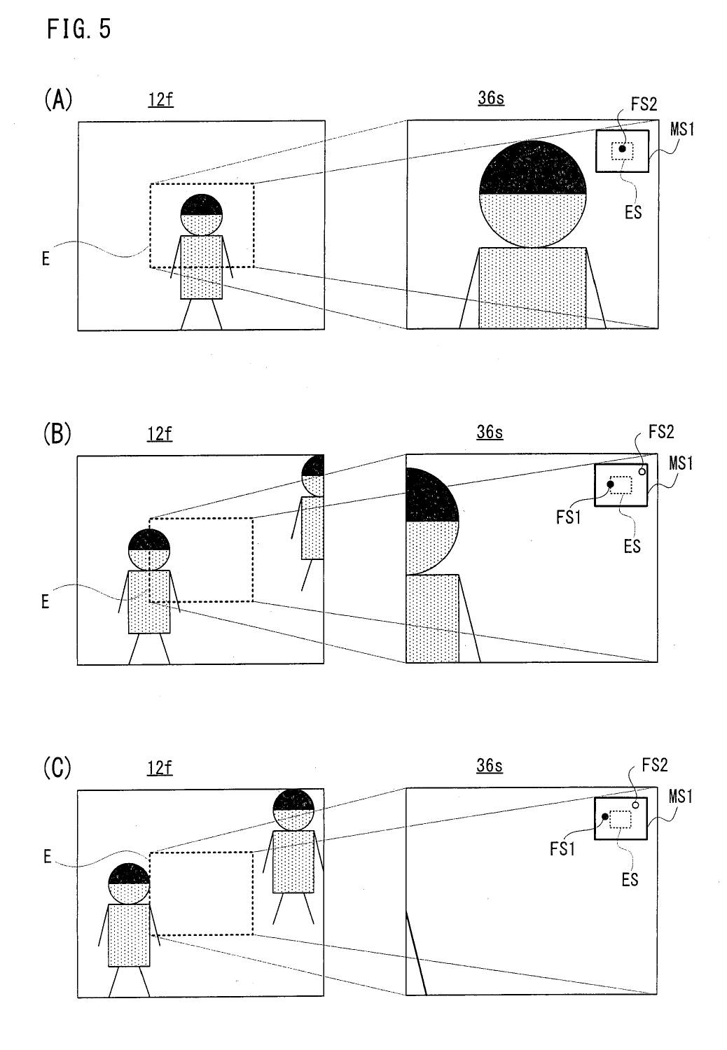

When a “face position displaying mode 2” is selected by the key input device 18, the mini-screen MS1 is immediately displayed, and the display of the mini-screen MS1 is continued until another mode is selected. That is, in this mode, as shown in FIG. 5(A)-FIG. 5(C), the mini-screen MS1 is always displayed irrespective of the positional relation between the facial image and the zoom area E.

Thus, in the face position displaying mode 1, the detected face position is displayed on the mini-screen MS1 from when the facial image which is being noted lies off the monitor screen 36s to when it returns to the monitor screen 36s, and in the face position displaying mode 2, the detected face position is always displayed on the mini-screen MS1. The features except for the feature of the display timing of the mini-screen MS1 are common to both modes.

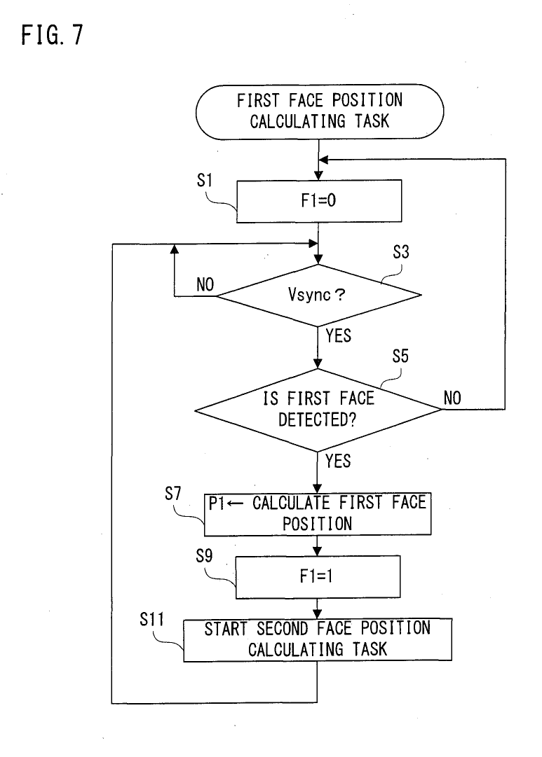

An operation relating to the face position display out of the aforementioned operations is implemented by execution of the controlling processing according to flowcharts shown in FIG. 7-FIG. 10 by the CPU 20. Here, the control program corresponding to these flowcharts is stored in the nonvolatile memory 38.

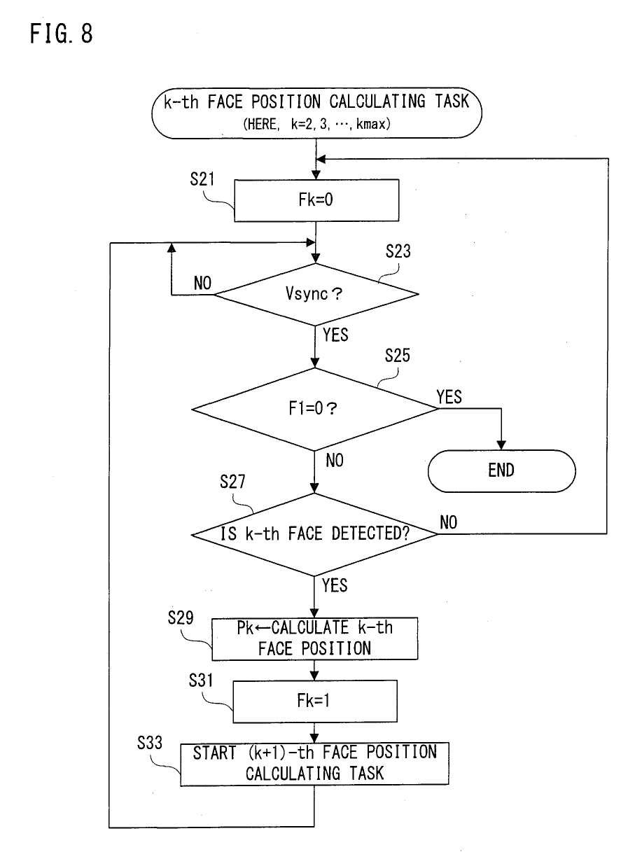

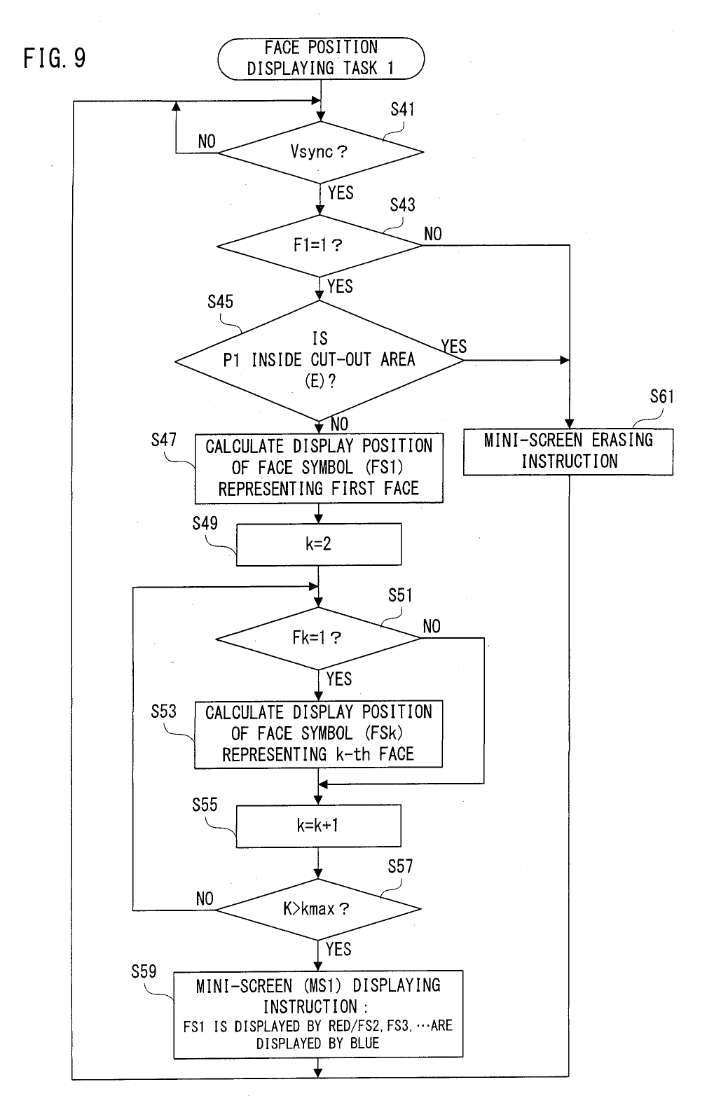

When the face position displaying mode 1 is selected, the CPU 20 executes, in parallel, first-k-th face position calculating tasks (k=2, 3, . . . , kmax, here) shown in FIG. 7 and FIG. 8 and a min-screen displaying task 1 shown in FIG. 9. Here, a variable k indicates the number of faces which is detected at this point. The parameter kmax is a maximum value of the variable k, that is, the simultaneously detectable number of faces (“4”, for example).

Referring to FIG. 7, in the first face position calculating task, in a first step S1, “0” is set to a variable F1, and then, in a step S3, generation of a Vsync is waited. When a Vsync is generated, the process shifts to a step S5 to determines whether or not a first face is detected. The first face here is the face given with the highest notice, and in a case that only one face is present within the object scene, the face is detected as a first face. In a case that a plurality of faces are present within the object scene, any one of the faces is selected on the basis of a positional relation, a magnitude relation, and a perspective relation among the faces. That is, the degree of notice among the plurality of faces is decided on the basis of a positional relation, a magnitude relation, a perspective relation, etc. among the plurality of faces. If “NO” in the step S5, the process returns to the step S1.

If “YES” in the step S5, the process shifts to a step S7 to calculate a position of the detected first face, and the calculation result is set to a variable P1. Then, in a step S9, “1” is set to the flag F1, and then, in a step S11, the second face position calculating task is started, and the process returns to the step S3.

Accordingly, while the first face is not detected, loop processing of steps S1 to S5 is executed at a cycle of 1/30 second and while the first face is detected, loop processing of steps S3 to S11 is executed at a cycle of 1/30 second. Thus, so long as the first face is detected, the variable P1 is updated for each frame as a result.

Referring to FIG. 8, in the k-th face position calculating task, in a first step S21, “0” is set to a flag Fk, and then, in a step S23, generation of a Vsync is waited. When a Vsync is generated, the process shifts to a step S25 to determine whether or not the flag F1 is “0”, and if “YES”, this task is ended.

If “NO” in the step S25, it is determined whether or not the k-th face is detected in a step S27. If only one face which has not yet been detected is present within the object scene, the face is detected as the k-th face. If a plurality of faces which have not yet been detected are present within the object scene, any one of the faces is selected on the basis of a positional relation, a magnitude relation, and a perspective relation among the faces. If “NO” in the step S27, the process returns to the step S21.

If “YES” in the step S27, the process shifts to a step S29 to calculate the position of the detected k-th face, and the calculation result is set to a variable Pk. Then, in a step S31, “1” is set to the flag Fk, and in a step S33, the (k+1)-th face position calculating task is started, and then, the process returns to the step S23.

Accordingly, while the k-th face is not detected, loop processing of steps S21 to S27 is executed at a cycle of 1/30 second, and while the k-th face is detected, loop processing of steps S23 to S33 is executed at a cycle of 1/30 second. Thus, the variable Pk is updated for each frame so long as the k-th face is detected. Furthermore, when the first face is not detected, that is, when the optical image of the face which is being noted lies outside the imaging area 12f, detection of the faces after the second face is ended, and detection of the first face is performed again.

Referring to FIG. 9, in the face position displaying task 1, in a first step S41, generation of a Vsync is waited, and when a Vsync is generated, the process shifts to a step S43 to determine whether or not the flag F1 is “1”. If “NO” here, the process proceeds to a step S61.

If “YES” in the step S43, the process shifts to a step S45 to determine whether or not the variable P1, that is, the position of the first face is within the zoom area E. If “YES” here, the process proceeds to the step S61.

If “NO” in the step S45, the display position of the face symbol FS1 representing the first face is calculated on the basis of the variable P1 in a step S47. This calculating processing corresponds to processing for evaluating a display position (230, 45) of the point P on the basis of the detected position (200, 500) of the point P in the aforementioned examples FIG. 6(A)-FIG. 6(C).

Next, in a step S49, “2” is set to the variable k, and then, in a step S51, it is determined whether or not the flag Fk is “1”, and if “NO”, the process proceeds to a step S55. If “YES” in the step S51, the display position of the face symbol FSk representing the k-th face is evaluated on the basis of the variable Pk in a step S53. After the calculation, the process proceeds to the step S55.

In the step S55, the variable k is incremented, and it is determined whether or not the variable k is above the parameter kmax in a next step S57. If “NO” here, the process returns to the step S51, and if “YES”, a display instruction of the mini-screen MS1 is issued in a step S59. The display instruction is attached with an instruction for displaying the first face symbol FS1 by red, the face symbols after the second FS2, FS3, . . . by blue. After the issuing, the process returns to the step S41.

In a step S61, a mini-screen erasing instruction is issued. After the issuing, the process returns to the step S41.

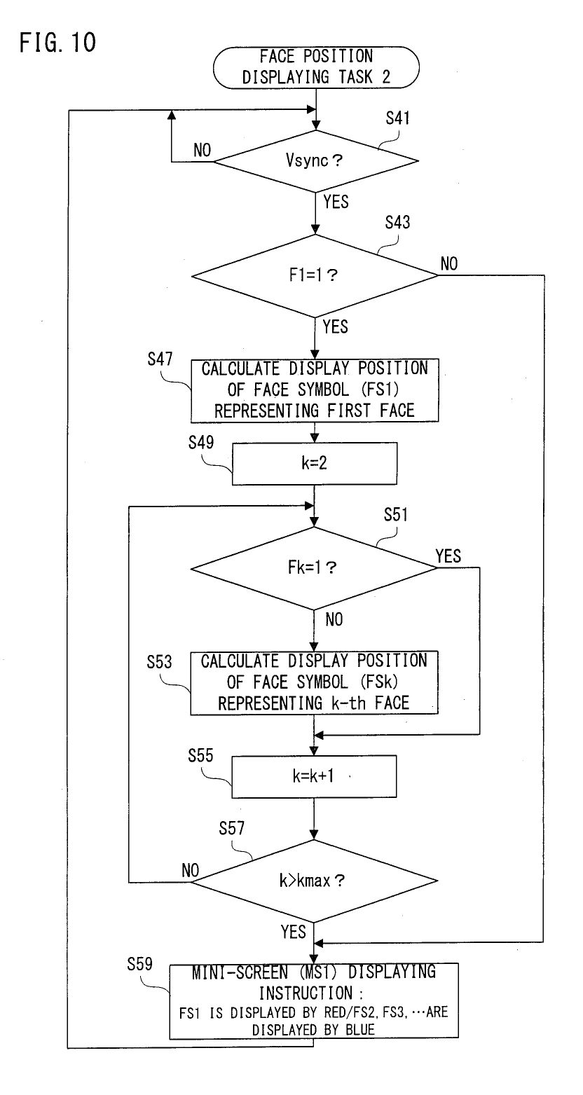

When the face position displaying mode 2 is selected, the CPU 20 executes in parallel the first to k-th face position calculating tasks shown in FIG. 7 and FIG. 8 and the mini-screen displaying task 2 shown in FIG. 10. Here, the mini-screen displaying task 2 shown in FIG. 10 is what the steps S45 and S61 are omitted from the mini-screen displaying task 1 shown in FIG. 9.

Referring to FIG. 10, if “YES” in the step S43, the process proceeds to a step S47, and if “NO” in the step S43, the process proceeds to a step S59. The other steps are the same or similar to those in FIG. 9, and the explanation therefor is omitted.

As understood from the above description, in this embodiment, the image sensor 12 repetitively captures the optical image of the object scene, and the zooming circuit 16 performs zoom processing on the partial object scene image belonging to the zoom area E of the object scene image produced by the image sensor 12. The zoomed object image thus produced is displayed on the monitor screen 36s by the LCD driver 34.

The CPU 20 detects a facial image from the produced object scene image through the face detecting circuit 22 (S7, S29), and displays the position information indicating the position of the detected facial image with respect to the zoom area E through the CG 28 and the LCD driver 34 on the mini-screen MS1 within the monitor screen 36s (S45-S61).

Accordingly, the user can know a positional relation with the monitor screen 36s (partial object scene image), that is, the positional relation between the facial image and the zoom area E by referring the mini-screen MS1. Thus, when the face disappears from the monitor screen 36s, the face can smoothly be introduced to the inside of the monitor screen 36s, that is, the facial image can smoothly be introduced into the zoom area E.

It should be noted that in this embodiment, the face symbol FS1 which is being noted and the face symbols FS2, FS3, . . . other than this are displayed by different colors, but alternatively, or in addition thereto, brightness, a size, a shape, transmittance, a flashing cycle, etc. may be differentiated.

However, in the first embodiment explained above, the position of the zoom area E is fixed, and the position of the facial image with respect to the zoom area E is displayed. On the contrary thereto, in the second embodiment explained next, the position of the zoom area E with respect to the imaging area 12f is displayed by causing the zoom area E to follow the movement of the facial image.

### Second Embodiment

The configuration of this embodiment is the same or similar to that of the first embodiment, and therefore, the explanation is omitted by using FIG. 1 for help. The basic operation (normal mode) is also common, and the explanation therefor is omitted. The feature of this embodiment is in an “automatically following+cut-out position displaying mode”, but this mode is partially common to the “face position displaying mode 2” in the first embodiment, and the explanation in relation to the common part is omitted. Additionally, FIG. 1 and FIG. 11-FIG. 15 are referred below.

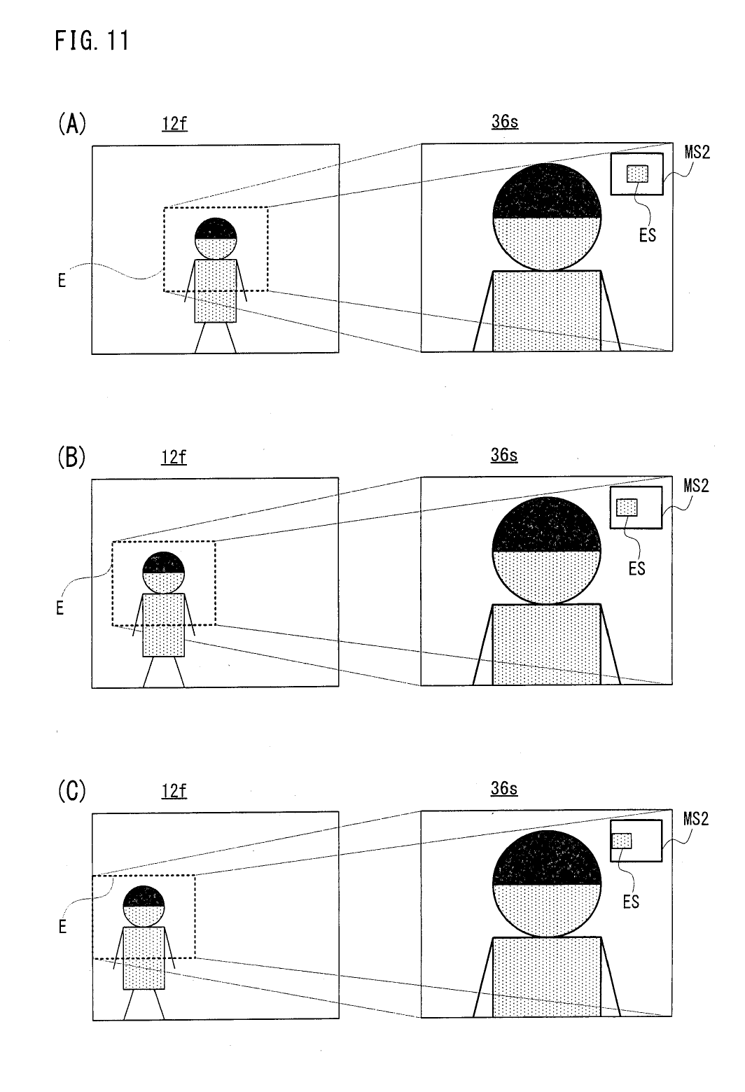

When the “automatically following+cut-out position displaying mode” is selected by the key input device 18, the mini-screen MS2 including the area symbol ES representing the position of the zoom area E is immediately displayed, and the display of the mini-screen MS2 is continued until another mode is selected. That is, in this mode, as shown in FIG. 11(A)-FIG. 11(C), the mini-screen MS2 is always displayed irrespective of the positional relation between the facial image and the zoom area E. Furthermore, as the zoom area E moves following the movement of the facial image, the area symbol ES also moves within the mini-screen MS2.

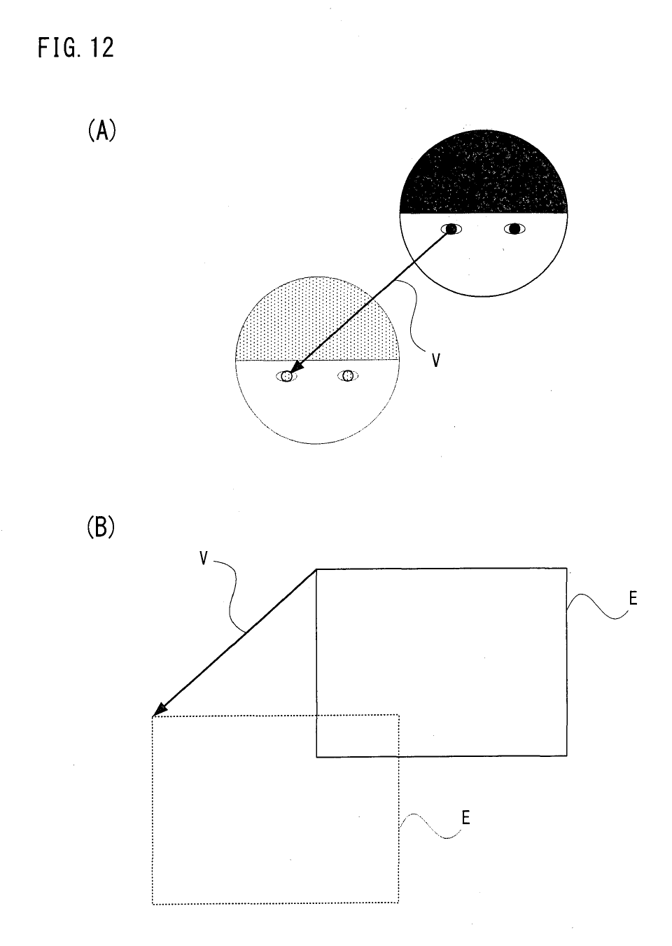

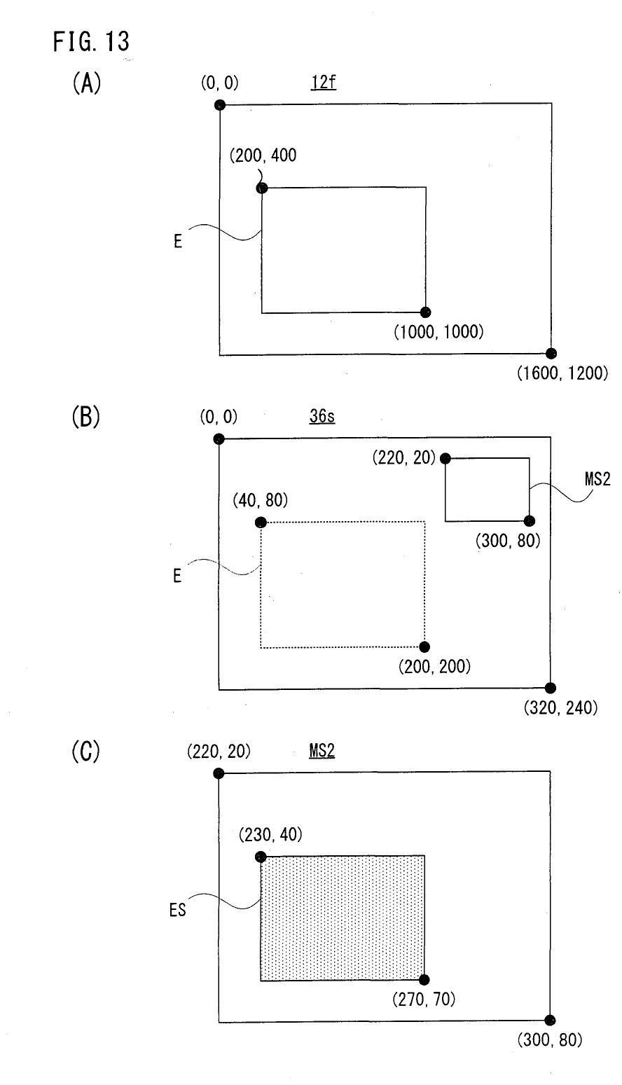

More specifically, as shown in FIG. 12(A) and FIG. 12(B), a movement vector V of the facial image is evaluated by noting one feature point from the detected facial image, i.e., one of the eyes, and the zoom area E is moved along the movement vector V. Next, in a manner shown in FIG. 13(A)-FIG. 13(C), a display position of the area symbol ES is evaluated. For example, if the zoom area E is at the position of (200, 400)-(1000, 1000), the display position of the area symbol ES becomes (230, 40)-(270, 70).

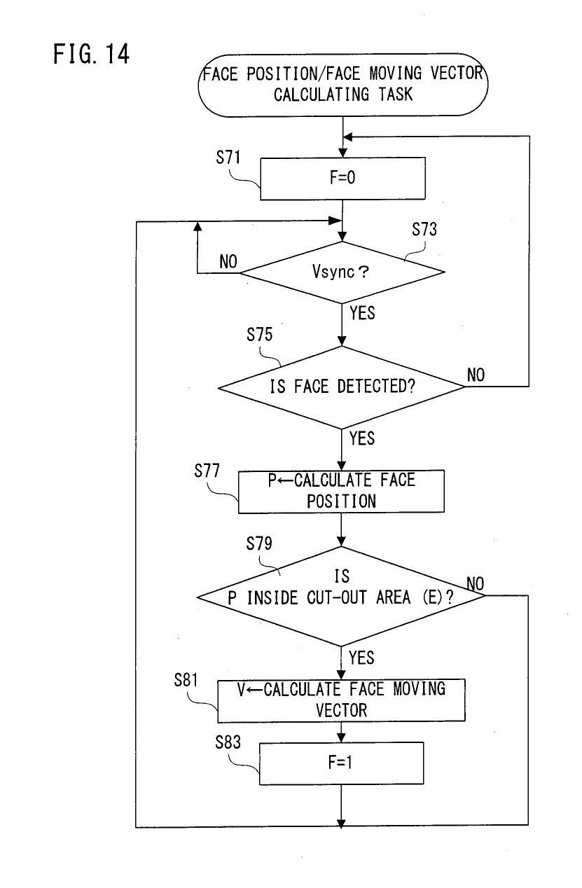

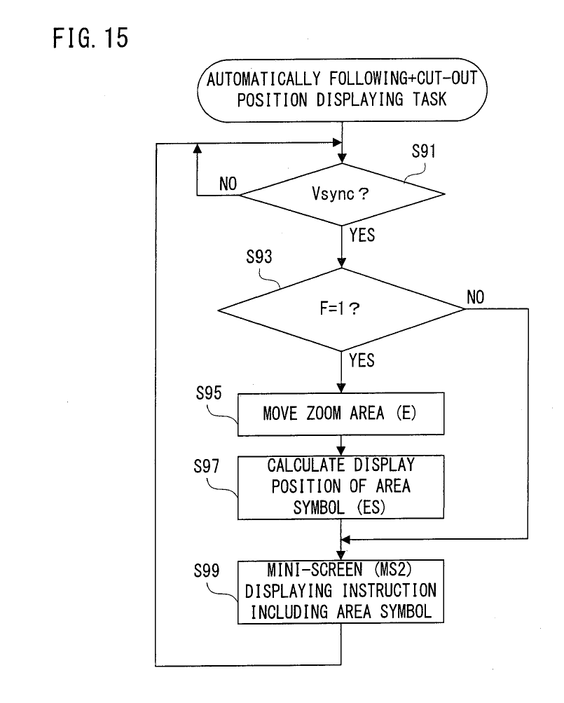

The cut-out position displaying operation as described above is implemented by the CPU 20 by executing the controlling processing according to flowcharts shown in FIG. 14 and FIG. 15. That is, when the automatically following+cut-out position displaying mode is selected, the CPU 20 executes in parallel a “face position/face moving vector calculating task” shown in FIG. 14 and an “automatically following+cut-out position displaying task” shown in FIG. 15.

Referring to FIG. 14, in the face position/face moving vector calculating task, in a first step S71, “0” is set to the variable F, and in a step S73, generation of a Vsync is waited. When a Vsync is generated, the process shifts to a step S75 to determine whether or not a face is detected. If “NO” here, the process returns to the step S71.

If “YES” in the step S75, the process shifts to a step S77 to calculate the position of the detected face, and set the calculation result to the variable P. In a next step S79, it is determined whether or not the variable P, that is, the face position is inside the zoom area E, and if “NO” here, the process returns to the step S73.

If “YES” in the step S79, a face moving vector is calculated in a step S81 (see FIG. 12(A)), and the calculation result is set to the variable V. Then, after “1” is set to the flag F in a step S83, the process returns to the step S73.

Accordingly, while the face is not detected, loop processing of steps S71 to S75 is executed at a cycle of 1/30 second and while the face is detected, loop processing of steps S73 to S83 is executed at a cycle of 1/30 second. Thus, so long as the face is detected, the variable P1 is updated for each frame, and consequently, so long as the face position is inside the zoom area E, the variable V is also updated for each frame.

Referring to FIG. 15, in the automatically following+cut-out position displaying task, in a first step S91, generation of a Vsync is waited, and when a Vsync is generated, the process shifts to a step S93 to determines whether or not the flag F is “1”. If “NO” here, the process proceeds to a step S99.

If “YES” in the step S93, the process shifts to a step S95 to move the zoom area E on the basis of the variable V (see FIG. 12(B)). In a next step S97, the display position of the area symbol ES is calculated on the basis of the position of the moved zoom area E (FIG. 13(A)-FIG. 13(C)), and then, the process proceeds to the step S99.

In the step S99, a display instruction of the mini-screen MS2 including the area symbol ES based on the calculation result in the step S97 is issued. In response thereto, the CG 28 generates image data of the mini-screen MS2, and the LCD driver 34 drives the LCD monitor 36 with the generated image data. Thus, the mini-screen MS2 representing the current zoom area E (cut-out position) is displayed on the monitor screen 36s (see FIG. 11(A)-FIG. 11(C)). Then, the process returns to the step S91.

As understood from the above description, in this embodiment, the image sensor 12 repetitively captures the optical image of the object scene, and the zooming circuit 16 performs zoom processing on the partial object scene image belonging to the zoom area E of the object scene image produced by the image sensor 12. The zoomed object image thus produced is displayed on the monitor screen 36s by the LCD driver 34.

The CPU 20 detects a facial image from the produced object scene image through the face detecting circuit 22 (S77), and causes the zoom area E to follow the displacement of the specific image when the detected specific image is inside the zoom area E (S81, S95). Furthermore, the position information representing the position of the zoom area E with respect to the imaging area 12f (that is object scene image) is displayed on the mini-screen MS2 within the monitor screen 36s through the CG 28 and the LCD driver 34 (S99).

Thus, on the monitor screen 36s, the zoomed object image belonging to the zoom area E of the object scene image is displayed. Since the zoom area E, here, follows the movement of the facial image, it is possible to maintain a state that the face is displayed within the monitor screen 36s.

On the other hand, on the mini-screen MS2, the position of the zoom area E with respect to the imaging area 12f (object scene image) is displayed, and therefore, it is possible for the user to know which part of the object scene image is displayed on the monitor screen 36s. Consequently, the user can adjust the direction of the optical axis of the image sensor 12 such that the zoom area E is arranged at the center of the imaging area 12f as precise as possible, and the range followed by the zoom area E is retained.

However, in the aforementioned first embodiment, the position of the facial image is indicated, but in a third embodiment explained next, the direction of the facial image is indicated.

### Third Embodiment

The configuration of this embodiment is the same or similar to that of the first embodiment, and therefore, the explanation is omitted by using FIG. 1 for help. The basic operation (normal mode) is also common, and the explanation therefor is omitted. The feature in this embodiment is in a “face direction displaying mode”, but this mode is partially common to the “face position displaying mode 1” in the first embodiment, and therefore, the explanation in relation to the common part is omitted. Additionally, FIG. 1 and FIG. 16-FIG. 20 are referred below.

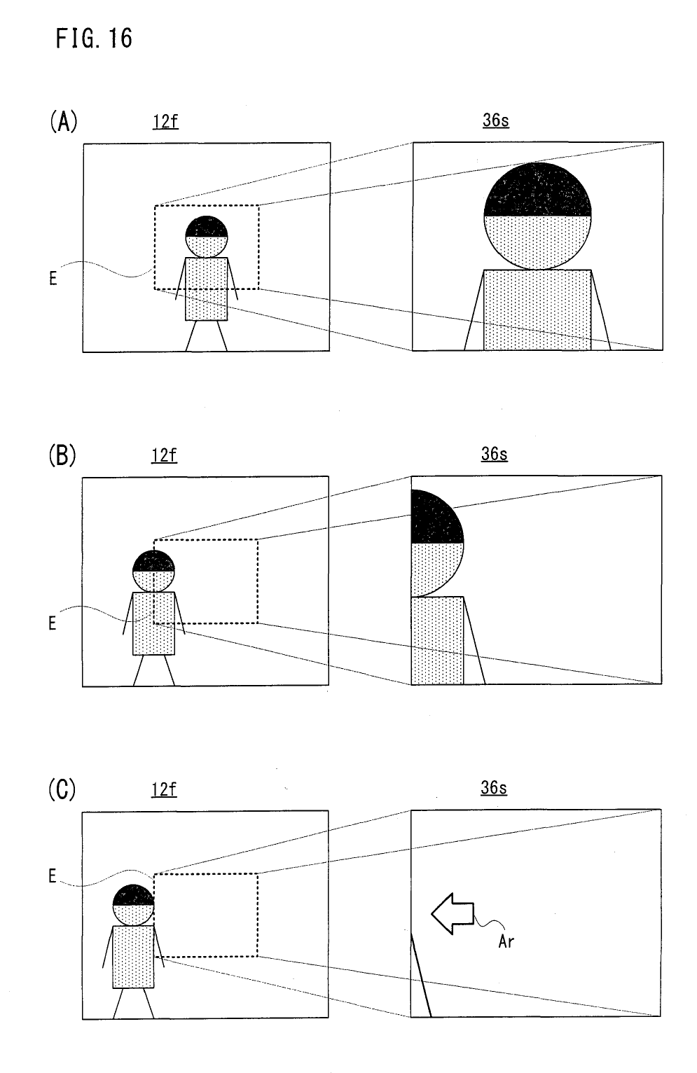

When the “face direction displaying mode” is selected by the key input device 18, in a case that the facial image which is being noted lies off the monitor screen 36s, an arrow Ar representing the direction in which the facial image exists is displayed on the monitor screen 36s as shown in FIG. 16(A)-FIG. 16(C).

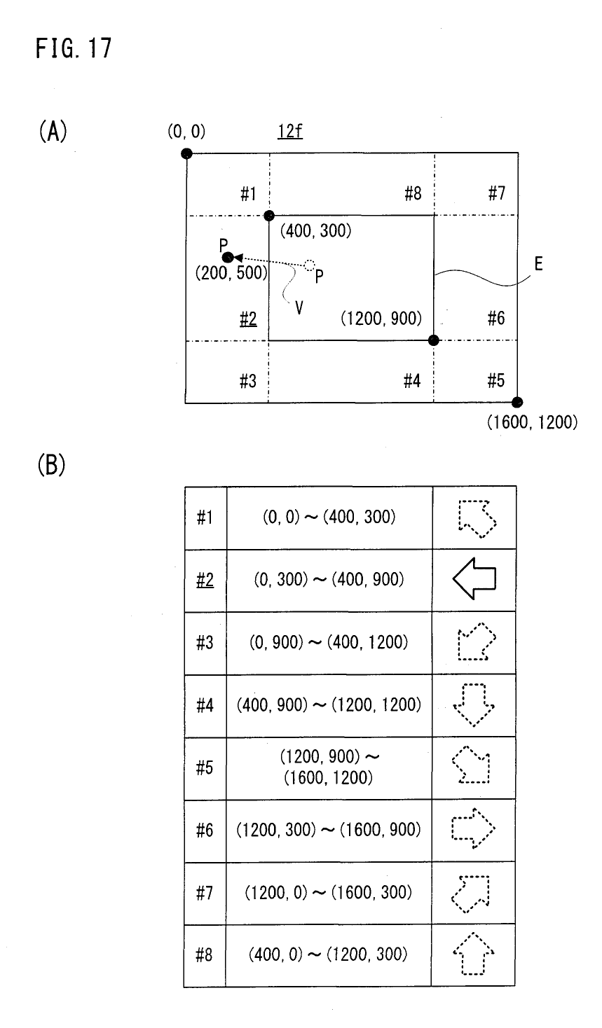

More specifically, as shown in FIG. 17(A), the part except for the zoom area E of the object scene corresponding to the imaging area 12f is divided into eight areas #1-#8. Next, as shown in FIG. 17(B), directions which are different from one another are assigned to the areas #1-#8 (upper left, left, lower left, down, lower right, right, upper right and up). Then, when the variable P, that is, the face position lies off the zoom area E, it is determined to which areas #1-#8 the current variable P belongs, and the corresponding direction is regarded as the direction of the arrow Ar. In this example, the current variable P, that is, (200, 500) belongs to the area #2, and the left arrow Ar is displayed.

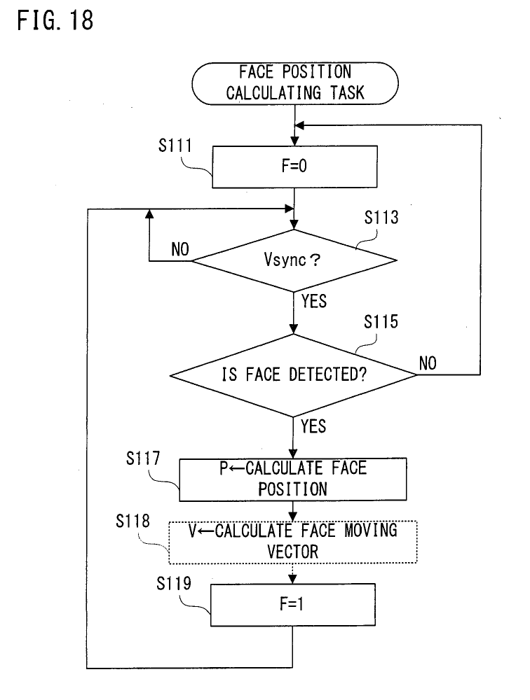

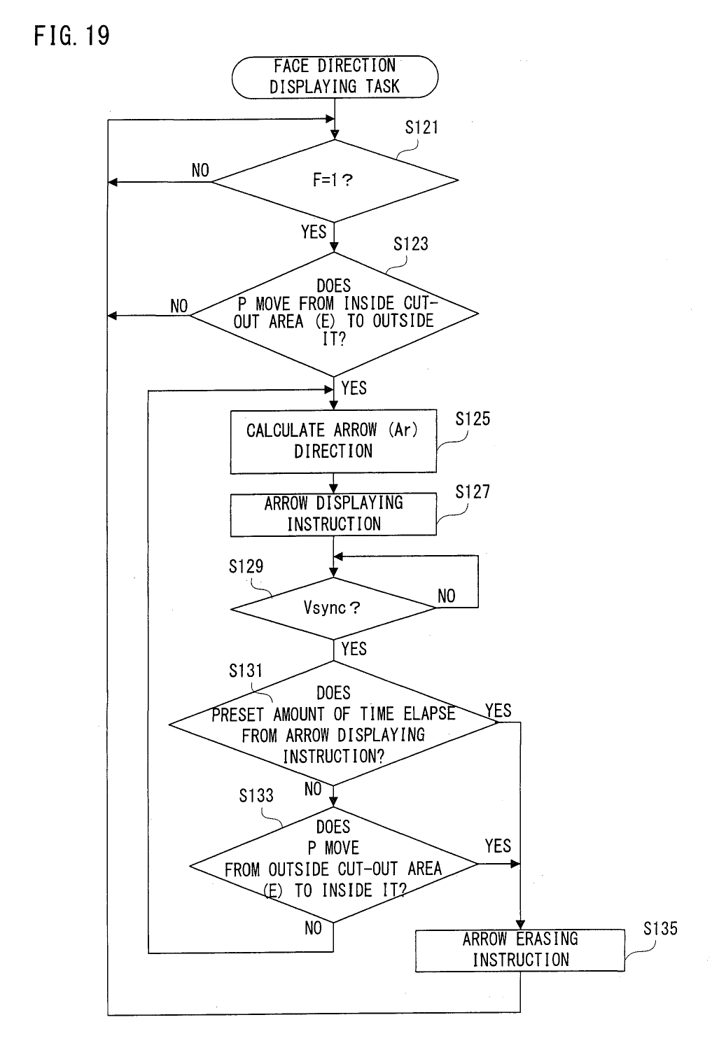

The face direction displaying operation as described above is implemented by executing controlling processing according to a flowchart shown in FIG. 18 and FIG. 19 by the CPU 20. That is, the CPU 20 executes a “face position calculating task” shown in FIG. 18 and a “face direction displaying task” shown in FIG. 19 in parallel when the face direction displaying mode is selected.

Referring to FIG. 18, in the face position calculating task, “0” is set to the variable F in a first step S111, and then, generation of Vsync is waited in a step S113. When a Vsync is generated, the process shifts to a step S115 to determine whether or not a face is detected. If “NO” here, the process returns to the step S111.

If “YES” in the step S115, the process shifts to a step S117 to calculate a position of the detected face, and set the calculation result to the variable P. Then, in a step S119, “1” is set to the flag F, and then, the process returns to the step S113.

Accordingly, while the face is not detected, loop processing of steps S111 to S115 is executed at a cycle of 1/30 second, and while the face is detected, loop processing of steps S113 to S119 is executed at a cycle of 1/30 second. Thus, so long as the face is detected, the variable P1 is updated for each frame.

Referring to FIG. 19, in the face direction displaying task, it is determined whether or not the flag F is “1” in a first step S121, and if “NO”, the process is on standby. If “YES” in the step S121, the process shifts to a step S123 to determine whether or not the variable P moves from inside the zoom area E to outside it, and if “NO” here, the process returns to the step S121. If the preceding variable P is inside the zoom area E, and the current variable P is outside the zoom area E, “YES” is determined in the step S123, and the process proceeds to a step S125.

In the step S125, the direction of the arrow Ar is evaluated on the basis of the variable P. For example, a direction from the preceding variable P toward the current variable P (see vector V: FIG. 17(A)) is calculated. In a succeeding step S127, an arrow display instruction based on the calculation result is issued. In response thereto, the CG 28 generates image data of the arrow Ar, and the LCD driver 34 drives the LCD monitor 36 with the generated image data. Thus, the arrow Ar indicating the face position is displayed on the monitor screen 36s (see FIG. 16(C)).

Then, in a step S129, generation of a Vsync is waited, and when a Vsync is generated, the process shifts to a step S131. In the step S131, it is determined whether or not a preset amount of time, 5 seconds, for example, elapses from issuing the arrow display instruction. If “NO” here, it is determined whether or not the variable P moves from outside the zoom area E to inside it in a step S133, and if “NO” here, the process returns to the step S125.

If “YES” in the step S131, or if “YES” in the step S133, an arrow erasing instruction is issued in a step S135. In response thereto, the generation processing by the CG 28 and the driving processing by the LCD driver 34 are stopped, and the arrow Ar is erased from the monitor screen 36s (see FIG. 16(A) and FIG. 16(B)). Then, the process returns to the step S121.

As understood from the above description, in this embodiment, the image sensor 12 repetitively captures the optical image of the object scene, and the zooming circuit 16 performs zoom processing on the partial object scene image belonging to the zoom area E of the object scene image produced by the image sensor 12. The zoomed object image thus produced is displayed on the monitor screen 36s by the LCD driver 34.

The CPU 20 detects the facial image from the produced object scene image through the face detecting circuit 22 (S117), and displays the arrow Ar indicating the direction of the facial image with respect to the zoom area E on the monitor screen 36s through the CG 28 and the LCD driver 34 (S127).

Accordingly, when the face disappears from the monitor screen 36s, by referring to the arrow Ar displayed on the monitor screen 36s, the user can know in which direction the face exists with respect to the monitor screen 36s, that is, the direction of the facial image with respect to the zoom area E. Thus, it is possible to smoothly introduce the face into the monitor screen 36s, that is, the facial image into the zoom area E.

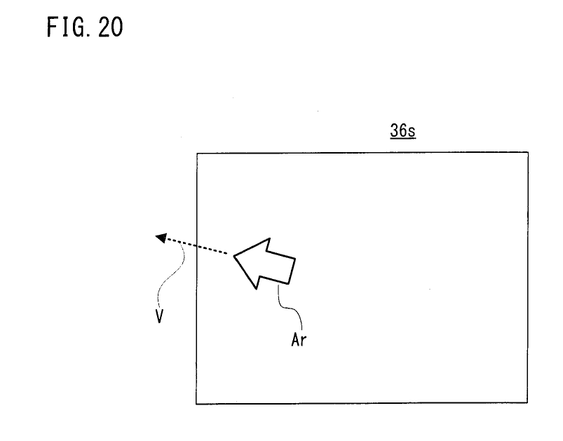

Additionally, in this embodiment, the direction of the arrow Ar is decided on the basis of the variable P, that is, the face position, but the direction of the arrow Ar may be decided on the basis of the face moving vector V as shown in FIG. 20.

In this case, in the face position calculating task in FIG. 18, a step S118 corresponding the step S81 shown in FIG. 14 is inserted between the step S117 and the step S119. In the step S118, the face moving vector V is calculated on the basis of the preceding variable P and the current variable P (see FIG. 17(A)), and the calculation result is set to the variable V. In the step S127 shown in FIG. 19, the direction of the arrow Ar is decided on the basis of the variable V (see FIG. 20(B)). This makes it possible to perform a more precise display of the direction.

By the way, in the aforementioned first embodiment, in the “face position displaying mode 1”, when a facial image lies outside the zoom area E, the position of the facial image is indicated, and in the third embodiment, when a facial image lies outside the zoom area E, the direction of the facial image is indicated, but in the fourth embodiment to be described next, when the facial image lies outside the zoom area E, the zoomed state is temporarily cancelled.

### Fourth Embodiment

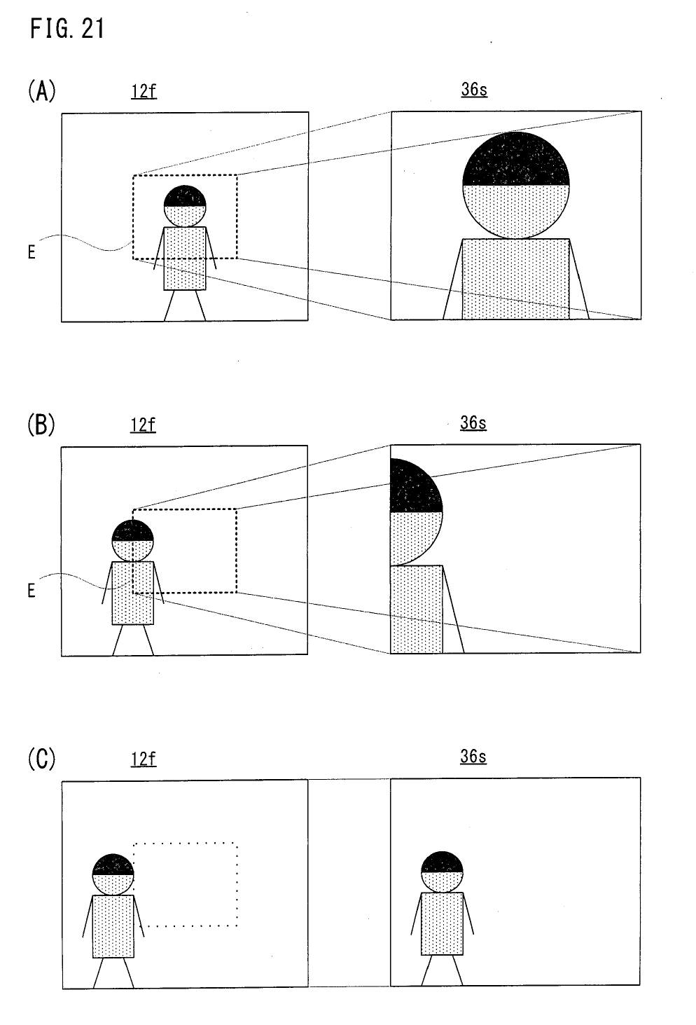

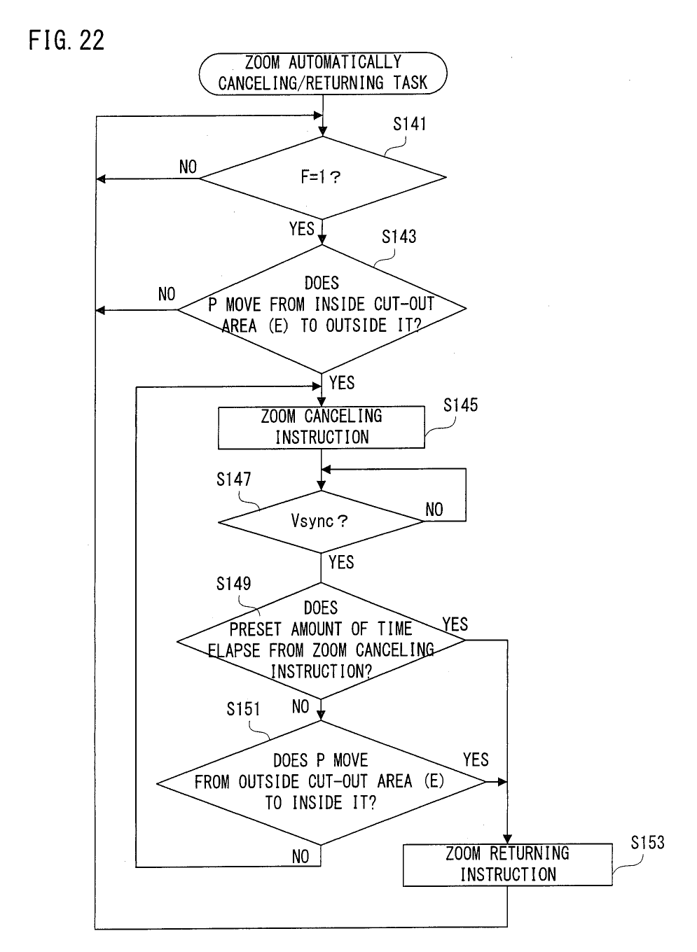

The configuration of this embodiment is the same or similar to that of the first embodiment, and therefore, the explanation is omitted by using FIG. 1 for help. The basic operation (normal mode) is also common, and the explanation therefor is omitted. The feature in this embodiment is in a “zoom-temporarily-canceling mode”, but this mode is partially common to the “face direction displaying mode” in the third embodiment, and the explanation in relation to the common part is omitted. Additionally, FIG. 1, FIG. 18, FIG. 21, and FIG. 22 are referred below.

When the “zoom-temporarily-canceling mode” is selected by the key input device 18, in a case that the facial image which is being noted lies outside the monitor screen 36s as shown in FIG. 21 (A) to FIG. 21 (C), the zoom is temporarily cancelled. That is, if the current zoom magnification is two times, the zoom magnification changes from 2× to 1× at a time when the face position moves from inside the zoom area E to outside it, and the zoom magnification is restored from 1× to 2× after the face position returns to the zoom area E.

The zoom temporarily cancelling operation as described above is implemented by execution of the controlling processing according to the flowchart shown in FIG. 18 and FIG. 22 by the CPU 20. That is, when the zoom-temporarily-canceling mode is selected, the CPU 20 executes the face position calculating task (described before) shown in FIG. 18 and a “zoom-temporarily-cancelling task” shown in FIG. 22 in parallel.

Referring to FIG. 22, in the zoom-temporarily-cancelling task, it is determined whether or not the flag F is “1” in a first step S141, and if “NO”, the process is on standby. If “YES” in the step S141, the process shifts to a step S143 to determine whether or not the variable P moves from inside the zoom area E to outside it, and if “NO” here, the process returns to the step S141. If the preceding variable P is inside the zoom area E, and the current variable P is outside the zoom area E, “YES” is determined in the step S143, and the process proceeds to a step S145.

In the step S145, a zoom cancelling instruction is issued. In response thereto, the set zoom magnification of the zooming circuit 16 is changed to 1×. Accordingly, at a time when the facial image is out of the monitor screen 36s, zooming out is automatically performed to make the facial image within the monitor screen 36s (see FIG. 21(C)).

Here, the timing of canceling the zoom is a time when the entire facial image is out of the zoom area E in this embodiment, but this may be a time when at least a part of the facial image is out of the zoom area E, or when the central point of the facial image is out of the zoom area E.

Then, generation of Vsync is waited in a step S147, and when a Vsync is generated, the process shifts to a step S149. In the step S149, it is determined whether or not a preset amount of time, i.e., 5 second elapses from issuing the arrow display instruction. If “NO” here, it is further determined whether or not the variable P moves from outside the zoom area E to inside it in a step S151, and if “NO” here, the process returns to the step S141.

If “YES” in the step S149, or if “YES” in the step S151, a zoom returning instruction is issued in a step S153. In response thereto, the set zoom magnification of the zooming circuit 16 is returned to the magnification before change from 1×. Thus, zooming in is performed at a time when the facial image returns to the zoom area E, and therefore, the facial image remains within the monitor screen 36s (see FIG. 21(A)).

As understood from the above description, in this embodiment, the image sensor 12 repetitively captures the optical image of the object scene, and the zooming circuit 16 performs zoom processing on the partial object scene image belonging to the zoom area E of the object scene image produced by the image sensor 12. The zoomed object image thus produced is displayed on the monitor screen 36s by the LCD driver 34.

The CPU 20 detects a facial image from the produced object scene image through the face detecting circuit 22 (S117), and cancels the zoomed state when the detected facial image moves from inside the zoom area E to outside it (S135). In response thereto, the object scene image produced by the image sensor 12 is displayed on the monitor screen 36s.

Accordingly, in response to the facial image lying off the screen, the angle of view is widened, and therefore, the face falls within the monitor screen 36s again. Thus, the user can smoothly introduce the facial image into the zoom area E.

Then, when a specific image detected after the cancelation of the zoom moves from outside the zoom area E to inside it, the zoomed state is returned (S153). In response thereto, the zoomed object image is displayed on the monitor screen 36s.

Here, in this embodiment, the zoomed state is canceled (that is, the zoom magnification is changed from 2× to 1×) in response to the facial image lying off the screen, but by reducing the zoom magnification, it is possible to easily introduce the facial image into the zoom area E. That is, the zoom cancelling/returning processing of this embodiment is one manner of the zoom magnification reducing/increasing processing.

In the above, an explanation is made on the digital camera 10, but the present invention can be applied to imaging devices having an electronic zooming function and a face detecting function, such as digital still cameras, digital movie cameras, mobile terminals with camera, etc.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An imaging device, comprising:
an imager for repeatedly capturing an optical image of an object scene;
a zoomer for performing zoom processing on a partial object scene image belonging to a zoom area out of the object scene image produced by said imager;
a first displayer for displaying a zoomed object image produced by said zoomer on a first screen;
a detector for detecting a specific image from the object scene image produced by said imager; and
a second displayer for displaying position information indicating a position of the specific image detected by said detector with respect to said zoom area on a second screen.

2. An imaging device according to claim 1, wherein
said second displayer displays said position information when the specific image detected by said detector lies outside said zoom area while it erases said position information when the specific image detected by said detector lies inside said zoom area.

3. An imaging device according to claim 1, wherein
said position information includes a specific symbol corresponding to the specific image detected by said detector and an area symbol corresponding to said zoom area, and
positions of said specific symbol and said area symbol on said second screen are equivalent to the positions of said specific image and said zoom area on said object scene image.

4. An imaging device according to claim 1, wherein
said detector includes a first detector for detecting a first specific image given with the highest notice and a second detector for detecting a second specific image given with a notice lower than that of said first specific image, and
said second displayer displays a first symbol corresponding to the detection result by said first detector and a second symbol corresponding to the detection result by said second detector in different manners.

5. An imaging device, comprising:
an imager for repeatedly capturing an optical image of an object scene;
a zoomer for performing zoom processing on a partial object scene image belonging to a zoom area of the object scene image produced by said imager;
a first displayer for displaying a zoomed object image produced by said zoomer on a first screen;
a detector for detecting a specific image from the object scene image produced by said imager;
a follower for causing said zoom area to follow a displacement of said specific image when the specific image detected by said detector lies inside said zoom area; and
a second displayer for displaying position information indicating a position of said zoom area with respect to the object scene image produced by said imager.

6. An imaging device according to claim 5, wherein
said position information includes an area symbol corresponding to said zoom area, and
a position of said area symbol on said second screen is equivalent to a position of said zoom area on said object scene image.

7. An imaging device, comprising:
an imager for repeatedly capturing an optical image of an object scene;
a zoomer for performing zoom processing on a partial object scene image belonging to a zoom area of the object scene image produced by said imager;
a first displayer for said zoomed object image produced by said zoomer on a screen;
a detector for detecting a specific image from the object scene image produced by said imager; and
a second displayer for displaying on said screen direction information indicating a direction of said specific image with respect to said zoom area when said specific image detected by said detector moves from inside said zoom area to outside the same.

8. An imaging device according to claim 7, further comprising
an erasure for erasing said direction information from said screen when the specific image detected by said detector moves from outside said zoom area to inside the same after the display by said second displayer.

9. An imaging device, comprising:
an imager for repeatedly capturing an optical image of an object scene;
a zoomer for performing zoom processing on a partial object scene image belonging to a zoom area of the object scene image produced by said imager;
a displayer for displaying a zoomed object image produced by said zoomer on a screen;
a detector for detecting a specific image from the object scene image produced by said imager; and
a zoom magnification reducer for reducing a zoom magnification of said zoomer when the specific image detected by said detector moves from inside said zoom area to outside the same, wherein
said displayer displays the object scene image produced by said imager on said screen in response to the zoom magnification reducing processing by said zoom magnification reducer.

10. An imaging device according to claim 9, further comprising:
a zoom magnification increaser for increasing the zoom magnification of said zoomer when the specific image detected by said detector moves from outside said zoom area to inside the same after the zoom magnification reduction by said zoom magnification reducer, wherein
said displayer displays said zoomed object image produced by said zoomer on said screen in response to the zoom magnification increasing processing by said zoom magnification increaser.

11. A recording medium storing a control program for imaging device, said imaging device comprising an imager for repetitively capturing an optical image of an object scene, a zoomer for performing zoom processing on a partial object scene image belonging to a zoom area of the object scene image produced by said imager, a first displayer for displaying a zoomed object image produced by said zoomer on a first screen, a detector for detecting a specific image from said object scene image produced by said imager, and a second displayer for displaying information in relation to the specific image detected by said detector on a second screen,
said program causes a processor of said imaging device to execute following steps of:
a position calculating step for calculating a position of the specific image detected by said detector with respect to said zoom area; and
a position information displaying step for instructing said second displayer to display position information indicating the position calculated by said calculating step on said second screen.

12. A recording medium storing a control program for imaging device, said imaging device comprising an imager for repeatedly capturing an optical image of an object scene, a zoomer for performing zoom processing on a partial object scene image belonging to a zoom area of the object scene image produced by said imager, a first displayer for displaying a zoomed object image produced by said zoomer on a first screen, a detector for detecting a specific image from said object scene image produced by said imager, and a second displayer for displaying information in relation to the specific image detected by said detector on a second screen,
said program causes a processor of said imaging device to execute following steps of:
a position calculating step for calculating a position of the specific image detected by said detector with respect to said zoom area;
a position change calculating step for calculating the change of the position when the position calculated by said position calculating step is inside said zoom area;
a zoom area moving step for instructing said zoomer to move said zoom area on the basis of the calculation result by said position change calculating step; and
a position information displaying step for instructing said second displayer to display the position information indicating the position calculated by said calculating step on said second screen.

13. A recording medium storing a control program for imaging device, said imaging device comprising an imager for repeatedly capturing an optical image of an object scene, a zoomer for performing zoom processing on a partial object scene image belonging to a zoom area of the object scene image produced by said imager, a first displayer for displaying a zoomed object image produced by said zoomer on a first screen, a detector for detecting a specific image from said object scene image produced by said imager, and a second displayer for displaying information in relation to the specific image detected by said detector on a second screen,
said program causes a processor of said imaging device to execute following steps of:
a position calculating step for calculating a position of the specific image detected by said detector with respect to said zoom area;
a direction calculating step for calculating, when the position calculated by said position calculating step moves from inside said zoom area to outside the same, a direction of the movement; and
a direction information displaying step for instructing said second displayer to display direction information indicating the direction calculated by said direction calculating step on said screen.

14. A recording medium storing control program for imaging device, said imaging device comprising an imager for repeatedly capturing an optical image of an object scene, a zoomer for performing zoom processing on a partial object scene image belonging to a zoom area of the object scene image produced by said imager, a displayer for displaying said zoomed object image produced by said zoomer on a screen, and a detector for detecting a specific image from the object scene image produced by said imager,
said program causes a processor of said imaging device to execute following steps of:
a position calculating step for calculating a position of the specific image detected by said detector with respect to said zoom area; and
a zoom magnification reducing step for reducing the zoom magnification of said zoomer when the position calculated by said calculating step moves from inside said zoom area to outside the same.
